(19) United States
(12) Patent Application Publication
(10) Pub. No.: US 2025/0330627 A1
(43) Pub. Date: Oct. 23, 2025

(54) Data Arrangement For Dynamic Mesh Coding

(71) Applicant: Bytedance Inc., Los Angeles, CA (US)

(72) Inventor: Jizheng Xu, San Diego, CA (US)

(21) Appl. No.: 19/256,945

(22) Filed: Jul. 1, 2025

Related U.S. Application Data
(63) Continuation of application No. PCT/US2024/010148, filed on Jan. 3, 2024.
(60) Provisional application No. 63/478,314, filed on Jan. 3, 2023.

(51) Int. Cl. H04N 19/46; G06T 9/00

(52) U.S. Cl. CPC H04N 19/46; G06T 9/001

(57) ABSTRACT

A mechanism for processing video data is disclosed. A determination is made to arrange displacement vectors and an attribute map of three-dimensional (3D) visual media data into a single picture for processing by a two-dimensional (2D) video codec. A conversion is performed between a visual media data and a bitstream based on the displacement vectors and the attribute map.

### CROSS-REFERENCE TO RELATED APPLICATIONS

This patent application is a continuation of International Patent Application No. PCT/US2024/010148, filed on Jan. 3, 2024, which claims the benefit of U.S. Provisional Patent Application No. 63/478,314 filed on Jan. 3, 2023, which is hereby incorporated by reference.

### TECHNICAL FIELD

The present disclosure relates to processing of digital images and video.

### BACKGROUND

Digital video accounts for the largest bandwidth used on the Internet and other digital communication networks. As the number of connected user devices capable of receiving and displaying video increases, the bandwidth demand for digital video usage is likely to continue to grow.

### SUMMARY

A first aspect relates to a method for processing video or image data, comprising: determining to arrange displacement vectors and an attribute map of three-dimensional (3D) visual media data into a single picture for processing by a two-dimensional (2D) codec; and performing a conversion between visual media data and a bitstream based on the displacement vectors and the attribute map.

Optionally, in any of the preceding aspects, another implementation of the aspect provides concatenating the displacement vectors and the attribute map to form the single picture.

Optionally, in any of the preceding aspects, another implementation of the aspect provides determining to arrange the displacement vectors and the attribute map in different parts of the single picture, and indicating location information or size information for each of the different parts in the bitstream.

Optionally, in any of the preceding aspects, another implementation of the aspect provides indicating the location information or the size information in a sequence parameter set (SPS), a picture parameter set (PPS), a video parameter set (VPS), a picture header, or a slice header of the bitstream.

Optionally, in any of the preceding aspects, another implementation of the aspect provides deriving the location information or the size information from information in a sequence parameter set (SPS), a picture parameter set (PPS), a video parameter set (VPS), a picture header, or a slice header of the bitstream.

Optionally, in any of the preceding aspects, another implementation of the aspect provides determining to arrange the displacement vectors and the attribute map in different parts of the single picture, wherein each of the different independent parts is capable of being decoded independently.

Optionally, in any of the preceding aspects, another implementation of the aspect provides determining to arrange the displacement vectors and the attribute map in different slices, different tiles, or different subpictures of the single picture.

Optionally, in any of the preceding aspects, another implementation of the aspect provides using a constrained intra prediction and/or a motion constrained tile set so that the displacement vectors and the attribute map are capable of being decoded independently.

Optionally, in any of the preceding aspects, another implementation of the aspect provides aligning the displacement vectors and the attribute map to a single bitdepth prior to determining to arrange the displacement vectors and the attribute map into the single picture.

Optionally, in any of the preceding aspects, another implementation of the aspect provides aligning a bitdepth of the displacement vectors to the attribute map so that the displacement vectors and the attribute map are aligned to the single bitdepth.

Optionally, in any of the preceding aspects, another implementation of the aspect provides aligning a bitdepth of the attribute map to the displacement vectors so that the displacement vectors and the attribute map are aligned to the single bitdepth.

Optionally, in any of the preceding aspects, another implementation of the aspect provides aligning a portion of data with a lower bitdepth to a portion of data with a higher bitdepth so that the displacement vectors and the attribute map are aligned to the single bitdepth.

Optionally, in any of the preceding aspects, another implementation of the aspect provides aligning the displacement vectors and the attribute map to a single color format prior to determining to arrange the displacement vectors and the attribute map into the single picture.

Optionally, in any of the preceding aspects, another implementation of the aspect provides aligning a color format of the displacement vectors to the attribute map so that the displacement vectors and the attribute map are aligned to the single color format.

Optionally, in any of the preceding aspects, another implementation of the aspect provides aligning a color format of the attribute map to the displacement vectors so that the displacement vectors and the attribute map are aligned to the single color format.

Optionally, in any of the preceding aspects, another implementation of the aspect provides aligning a portion of data with a less color format information to a portion of data with more color format information so that the displacement vectors and the attribute map are aligned to the single color format.

Optionally, in any of the preceding aspects, another implementation of the aspect provides determining to arrange a motion field of meshes along with the displacement vectors and the attribute map into the single picture for processing by the 2D codec.

Optionally, in any of the preceding aspects, another implementation of the aspect provides determining to arrange any two parts or all parts of the motion field of meshes, the displacement vectors, and the attribute map into the single picture for processing by the 2D codec.

Optionally, in any of the preceding aspects, another implementation of the aspect provides aligning any two parts or all parts of the motion field of meshes, the displacement vectors, and the attribute map to a single bitdepth prior to determining to arrange the motion field of meshes, the displacement vectors, and the attribute map into the single picture.

Optionally, in any of the preceding aspects, another implementation of the aspect provides aligning any two parts or all parts of the motion field of meshes, the displacement vectors, and the attribute map to a single color format prior to determining to arrange the motion field of meshes, the displacement vectors, and the attribute map into the single picture.

Optionally, in any of the preceding aspects, another implementation of the aspect provides that the single color format comprises two or more parts of the motion field of meshes, the displacement vectors, and the attribute map having the most color information.

Optionally, in any of the preceding aspects, another implementation of the aspect provides determining to arrange any data capable of being processed by the 2D codec into the single picture for processing by the 2D codec.

Optionally, in any of the preceding aspects, another implementation of the aspect provides determining to arrange two or more parts of an occupancy map, a geometry map, and an attribute map of video-based point cloud coding into the single picture for processing by the 2D codec.

Optionally, in any of the preceding aspects, another implementation of the aspect provides determining to arrange an occupancy map and a geometry map consistent with the moving picture experts group (MPEG) immersive video standard into the single picture for processing by the 2D codec.

Optionally, in any of the preceding aspects, another implementation of the aspect provides aligning any data arranged into the single picture to a same bitdepth.

Optionally, in any of the preceding aspects, another implementation of the aspect provides determining to arrange only data with a same bitdepth into the single picture.

Optionally, in any of the preceding aspects, another implementation of the aspect provides that any data with a different bitmap is not arranged into the single picture.

Optionally, in any of the preceding aspects, another implementation of the aspect provides aligning any data arranged in the single picture to have a same color format.

Optionally, in any of the preceding aspects, another implementation of the aspect provides determining to arrange only data with a same color format into the single picture.

Optionally, in any of the preceding aspects, another implementation of the aspect provides that any data with a different bitdepth is not arranged into the single picture.

Optionally, in any of the preceding aspects, another implementation of the aspect provides determining to arrange only data with a same bitdepth and a same color format into the single picture.

Optionally, in any of the preceding aspects, another implementation of the aspect provides that any data with a different bitdepth or a different color format is not arranged into the single picture.

Optionally, in any of the preceding aspects, another implementation of the aspect provides determining to arrange any combination of a motion field of meshes, the displacement vectors, and the attribute map of 3D visual media data.

Optionally, in any of the preceding aspects, another implementation of the aspect provides that the conversion includes encoding the media data into a bitstream.

Optionally, in any of the preceding aspects, another implementation of the aspect provides that the conversion includes decoding the media data from a bitstream.

A second aspect comprises an apparatus for processing media data comprising: a processor; and a non-transitory memory with instructions thereon, wherein the instructions upon execution by the processor, cause the processor to perform the method of any of the disclosed embodiments.

A third aspect relates to a non-transitory computer readable medium, comprising a computer program product for use by a video coding device, the computer program product comprising computer executable instructions stored on the non-transitory computer readable medium such that when executed by a processor cause the video coding device to perform the method of any of the disclosed embodiments.

A fourth aspect relates to a non-transitory computer-readable recording medium storing a bitstream of a video which is generated by a method performed by a video processing apparatus, wherein the method comprises the method of any of the disclosed embodiments.

A fifth aspect relates to a method for storing a bitstream of a video comprising the method of any of the disclosed embodiments.

A sixth aspect relates to a method, apparatus, or system described in the present disclosure.

For the purpose of clarity, any one of the foregoing embodiments may be combined with any one or more of the other foregoing embodiments to create a new embodiment within the scope of the present disclosure.

These and other features will be more clearly understood from the following detailed description taken in conjunction with the accompanying drawings and claims.

### BRIEF DESCRIPTION OF THE DRA WINGS

For a more complete understanding of this disclosure, reference is now made to the following brief description, taken in connection with the accompanying drawings and detailed description, wherein like reference numerals represent like parts.

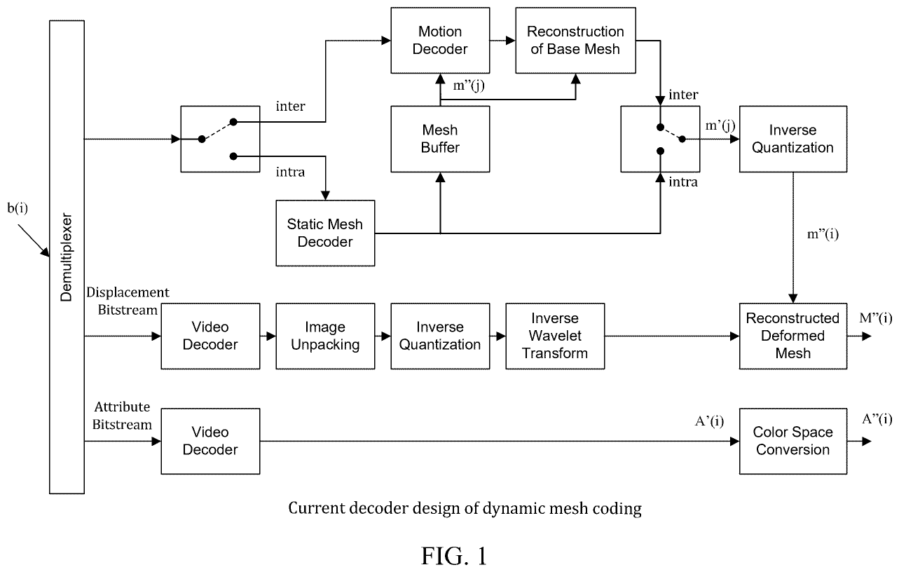

FIG. 1 is a schematic diagram illustrating an example decoder design for dynamic mesh coding.

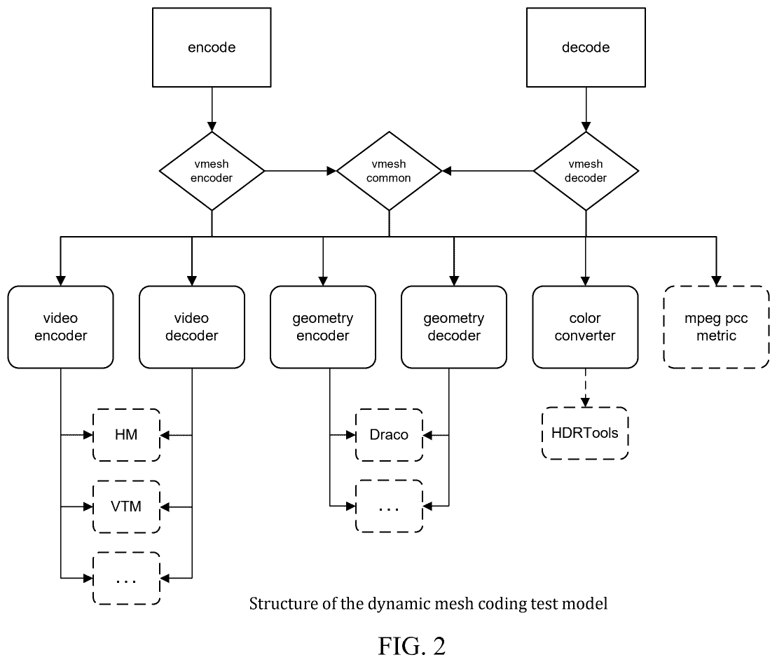

FIG. 2 is a schematic diagram illustrating an example structure for a dynamic mesh coding test model.

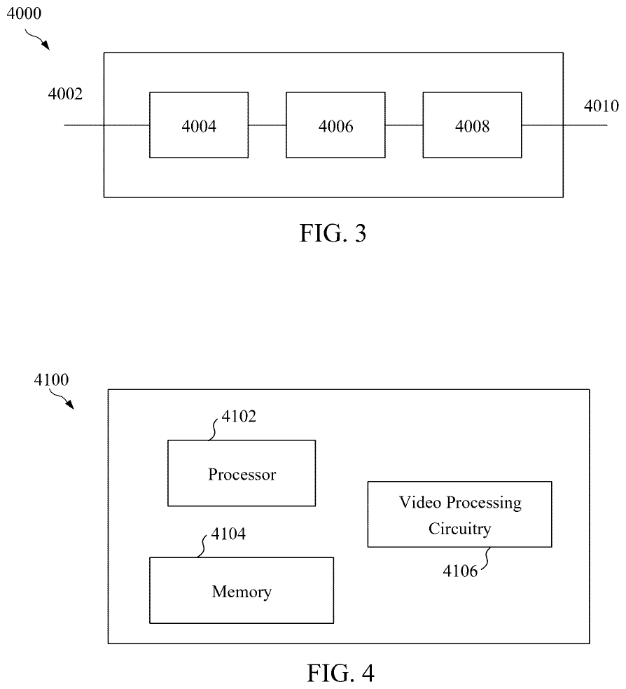

FIG. 3 is a block diagram showing an example video processing system.

FIG. 4 is a block diagram of an example video processing apparatus.

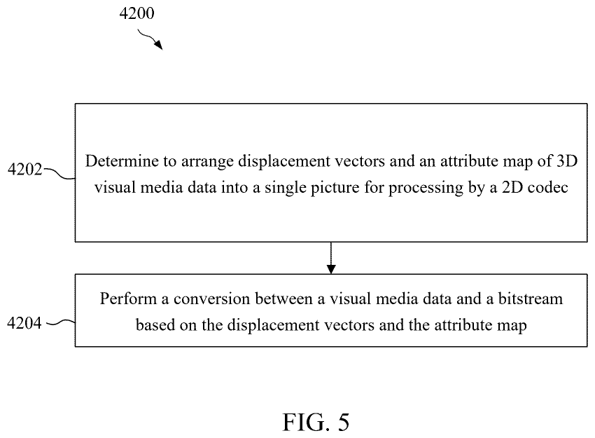

FIG. 5 is a flowchart for an example method of video processing.

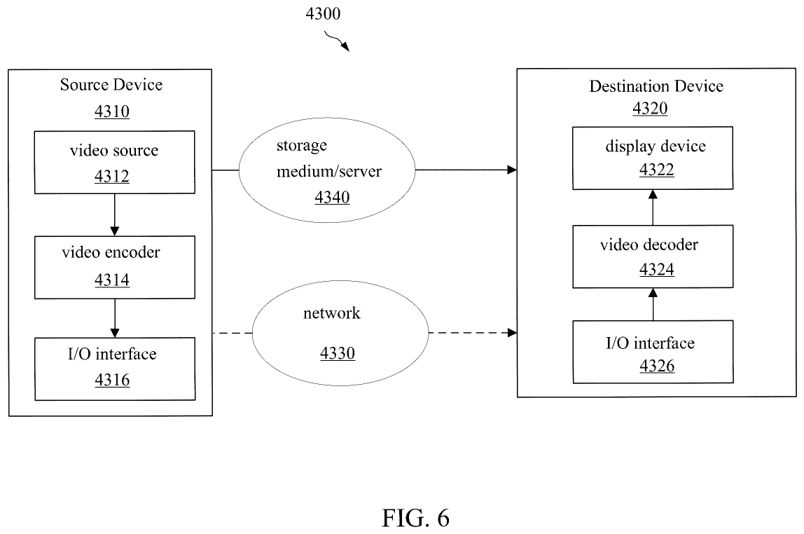

FIG. 6 is a block diagram that illustrates an example video coding system.

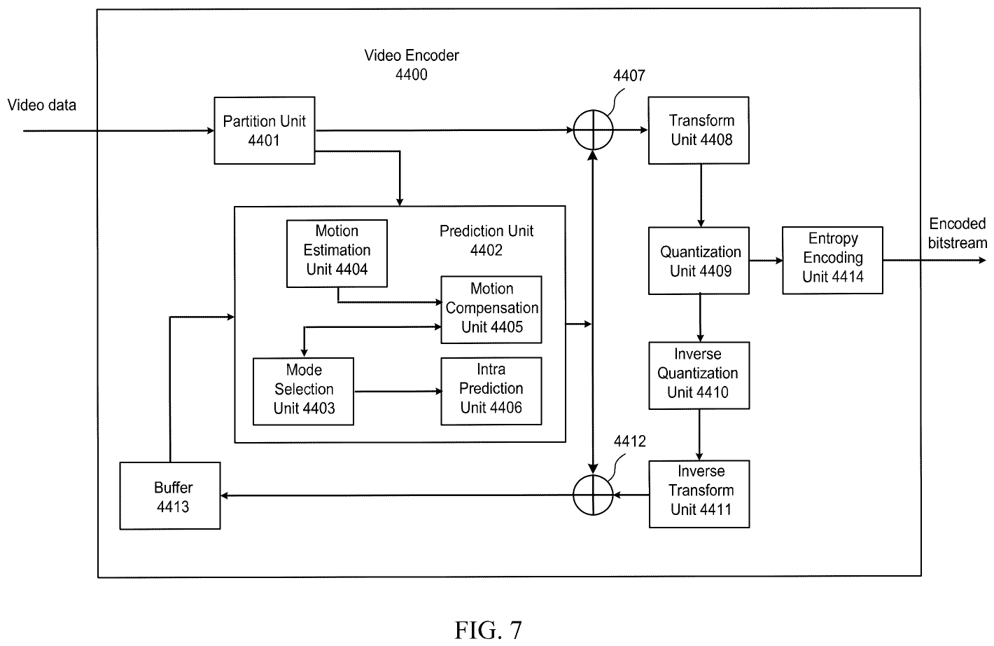

FIG. 7 is a block diagram that illustrates an example encoder.

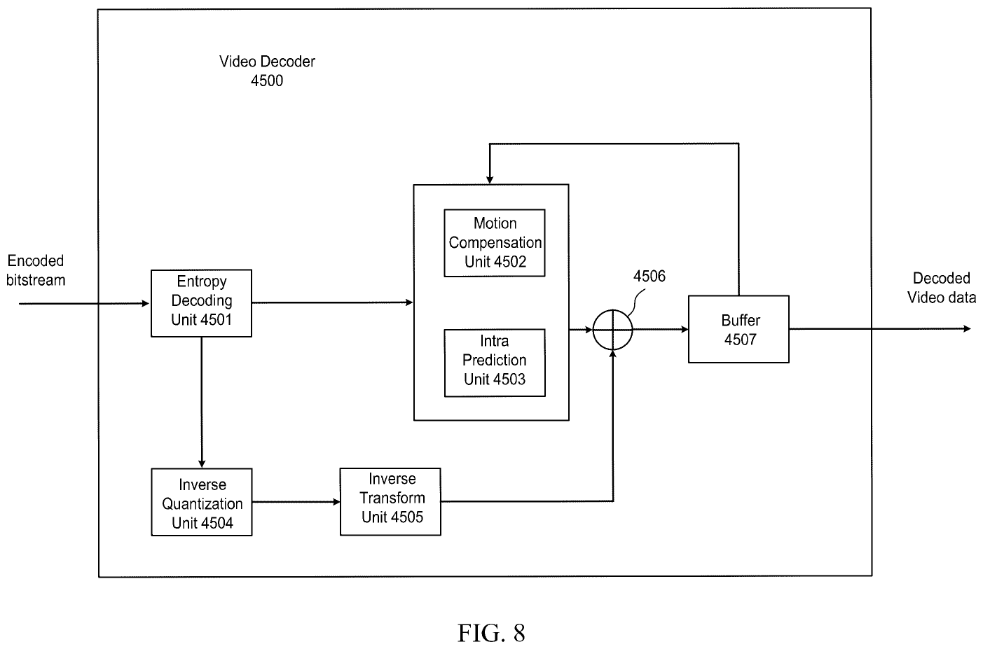

FIG. 8 is a block diagram that illustrates an example decoder.

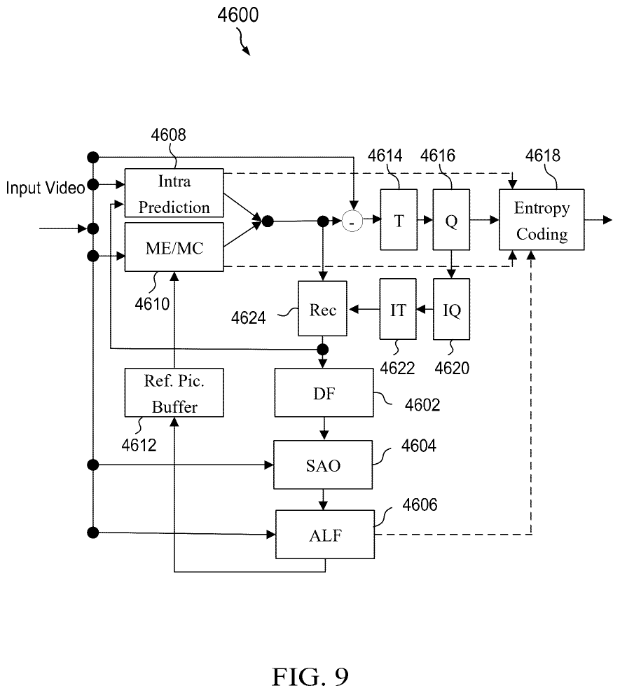

FIG. 9 is a schematic diagram of an example encoder.

### DETAILED DESCRIPTION

It should be understood at the outset that although an illustrative implementation of one or more embodiments are provided below, the disclosed systems and/or methods may be implemented using any number of techniques, whether currently known or yet to be developed. The disclosure should in no way be limited to the illustrative implementations, drawings, and techniques illustrated below, including the exemplary designs and implementations illustrated and described herein, but may be modified within the scope of the appended claims along with their full scope of equivalents.

### 1. Initial Discussion

The present disclosure is related to immersive video coding technologies. Specifically, it is related to Motion Picture Expert Group (MPEG)-I video-based dynamic mesh coding. It may be also applicable to other immersive video coding standards or codecs.

### 2. Further Discussion

In computer graphics, a three dimensional (3D)/immersive content can usually be represented by a 3D mesh and a texture map. Those mesh and texture data can be generated by a machine or can be converted from images captured by multiple cameras from different angles. Similar to two dimensional (2D) video, when those 3D contents change with time, the mesh and texture data also change and consist a sequence of dynamic mesh. The data volume of dynamic mesh are usually huge and make it difficult to store and transmit. To meet the requirements of applications that use dynamic mesh, MPEG issued a call for proposal. To efficiently use 2D codecs, one of the requirements is to use a 2D video coding standard to compress most data and keep other parts simple and of low complexity. Such a requirement can guarantee that the representation can take advantages of the 2D video hardware/software systems, without much efforts to redesign a specific system just for dynamic mesh.

MPEG received 5 responses to the call for proposal. A test model was built for the development of the planned dynamic mesh coding standard.

The latest test model of dynamic mesh coding until this disclosure is drafted can be found via this link http://mpegx.int-evry.fr/software/MPEG/dmc/mpeg-vmesh-tm/-/tags/v2.0; and the latest working draft document is working draft (WD) 1.0.

### 2.1 Data Representation in Dynamic Mesh Coding

FIG. 1 is a schematic diagram illustrating an example decoder design for dynamic mesh coding. FIG. 1 shows an example decoder design. It can be seen that a dynamic mesh decoder receives 3 bitstreams and performs decoding to reconstruct the dynamic mesh plus texture signals. The first bitstream is to represent the base mesh, a decimated version of the original mesh. The second bitstream is to represent displacement vectors between the reconstructed base mesh and the original mesh. The displacement vectors are arranged as a 2D video and compressed with an 2D video coding standard compliant codec. The third bitstream is to represent the texture (or attribute map). The attribute map is also arranged as a 2D video and compressed with an 2D video coding standard compliant codec. The design philosophy is to make the base mesh part small enough so that the module to process the base mesh can be implemented simply. On the other hand, the displacement vectors and the attribute map accounts for most volume of the whole dynamic mesh data, which can be processed with dedicated high efficient 2D video coding systems. Such a design can reduce the extra efforts to implement the dynamic mesh coding system and guarantee the high throughout and coding efficiency for the dynamic mesh data.

### 2.2 Test Model of Dynamic Mesh Coding

FIG. 2 is a schematic diagram illustrating an example structure for a dynamic mesh coding test model. In the model, Draco is used to compress base mesh and the high efficiency video coding (HEVC) test model (HM) is used to compress displacement vectors and attribute map. However, it should be noted that other mesh or video coding systems can also be used in dynamic mesh coding.

The base mesh m is generated from the original mesh with a down-sampling scheme. Its quantized version m′ is then coded using Draco. The reconstructed base mesh m″ can be obtained by inverse quantization of m′. Displacement vectors d′ are generated by making the difference between the original mesh and the subdivided version of m″ using a subdivision scheme.

### 2.3 Coding of Displacement Vectors

After obtaining displacement vectors d′, the difference between the original mesh and the subdivided base mesh, a lifting-based wavelet transform is applied to further make the energy compact. Then the wavelet transform coefficients are traversed from low to high frequency using a Morton order to form 2D coefficient blocks. Various 2D coefficient blocks comprise a picture to be processed by a 2D codec.

### 2.4 Motion Field Coding

In an example test model, motion fields between base meshes are directly coded using arithmetic coding. An example implementation investigates coding of motion fields also with a standard compliant 2D coding system and showed that the coding efficiency loss is marginal. Thus, it may make sense to further shift the coding process of motion field to a 2D video codec.

### 3. Technical Problems Solved by Disclosed Technical Solutions

In an example design of dynamic mesh coding, multiple video coding bitstreams are needed to be processed, which may prohibit the scheme from being deployed in video encoding/decoding systems that can just handle one video bitstream. Further, this issue may reduce the throughput and/or efficiency of the whole system even it can handle multiple video bitstreams.

### 4. a Listing of Solutions and Embodiments

The detailed aspects below should be considered as examples to explain general concepts. These examples should not be interpreted in a narrow way. Furthermore, these examples can be combined in any manner. Combinations between this disclosure and other disclosures are also applicable.
1. Displacement vectors and attribute map may be arranged in one picture to be processed by a 2D image/video codec.
   a. In one example, displacement vectors and attribute map may be concatenated to form a picture.
   b. In one example, displacement vectors and attribute map may be arranged in different parts of one picture with the location and/or size information of each part indicated in the video bitstream.
      i. In one example, the location and/or size information of each part may be signalled in sequence parameter set (SPS)/picture parameter set (PPS)/video parameter set (VPS)/Picture header/Slice header.
      ii. In one example, the location and/or size information of each part may be derived from the information in SPS/PPS/VPS/Picture header/Slice header.
   c. In one example, displacement vectors and attribute map may be arranged in different parts of one picture, with each part capable to be decoded independently.
      i. In one example, displacement vectors and attribute map may be arranged in different slices/tiles/subpicture of one picture.
      ii. In one example, constrained intra prediction and/or motion constrained tile set may be used to make displacement vectors and attribute map capable to be decoded independently.
   d. In one example, displacement vectors and attribute map may be aligned to one bitdepth and then arranged in one picture.
      i. In one example, displacement vectors' bitdepth may be aligned to attribute map.
      ii. In one example, attribute map's bitdepth may be aligned to displacement vectors.
      iii. In one example, one part of data with lower bitdepth may be aligned to the other part with higher bitdepth.
   e. In one example, displacement vectors and attribute map may be aligned to one colour format and then arranged in one picture.
      i. In one example, displacement vectors' colour format may be aligned to attribute map.
      ii. In one example, attribute map's colour format may be aligned to displacement vectors.
      iii. In one example, one part of data with less colour information may be aligned to the other part with more colour information.
2. Motion field of meshes and displacement vectors may be arranged in one picture to be processed by a 2D image/video codec.
   a. In one example, motion field of meshes and displacement vectors may be arranged in one picture and above bullets/sub-bullets may be applied.
3. Motion field of meshes and attribute map may be arranged in one picture to be processed by a 2D image/video codec.
   a. In one example, motion field of meshes and attribute map may be arranged in one picture and above bullets/sub-bullets may be applied.
4. Motion field of meshes, displacement vectors and attribute map may be arranged in one picture to be processed by a 2D video image/codec.
   a. In one example, motion field of meshes and attribute map may be arranged in one picture and above bullets/sub-bullets may be applied.
   b. In one example, any two or all parts of motion field of meshes, displacement vectors and attribute map may be arranged in one picture.
   c. In one example, any two or all parts of motion field of meshes, displacement vectors and attribute map may be aligned to one bitdepth and then arranged in one picture.
      i. In one example, the bitdepth is the maximum bitdepth of any two or all parts.
   d. In one example, any two or all parts of motion field of meshes, displacement vectors and attribute map may be aligned to one colour format and then arranged in one picture.
      i. In one example, the colour format is the one with the most colour information of any two or all parts.
5. Multiple or all data that can be processed by a 2D image/video codec in a coding system may be arranged in one picture.
   a. In one example, any two or all parts of occupancy map, geometry and attribute in the video-based point cloud coding may be arranged in one picture and above bullets/sub-bullets may be applied.
   b. In one example, geometry and attribute in the MPEG immersive video standard may be arranged in one picture and above bullets/sub-bullets may be applied.
   c. In one example, the data arranged in one picture may be aligned to have the same bitdepth.
   d. In one example, only data with the same bitdepth may be arranged in one picture.
      i. Alternatively, data with different bitdepth may not be arranged in one picture.
   e. In one example, the data arranged in one picture may be aligned to have the same colour format.
   f. In one example, only data with the same colour format may be arranged in one picture.
      i. Alternatively, data with different bitdepth may not be arranged in one picture.
   g. In one example, only data with the same bitdepth and the same colour format may be arranged in one picture.
      i. Alternatively, data with different bitdepth or different colour format may not be arranged in one picture.

### 5. References

[1] MPEG technical requirements, “CfP for. Dynamic Mesh Coding,” ISO/IEC JTC 1/SC 29/WG 2 doc. no. N145, in October 2021.
[2] K. Mammou, J. Kim, A. Tourapis and D. Podborski, “[V-CG] Apple's Dynamic Mesh Coding CfP Response,” ISO/IEC JTC 1/SC 29/WG 7 doc. no. m59281, in April 2022.
[3] MPEG output document, “WD 1.0 of V-DMC,” ISO/IEC JTC 1/SC 29/WG 7 doc. no. N0486, in November 2022.
[4] C. Huang, X. Xu, X. Zhang, J. Tian and S. Liu, “Investigation of video coding of motion fields,” ISO/IEC JTC 1/SC 29/WG 7 doc. no. m61005, in July 2022.

FIG. 3 is a block diagram showing an example video processing system 4000 in which various techniques disclosed herein may be implemented. Various implementations may include some or all of the components of the system 4000. The system 4000 may include input 4002 for receiving video content. The video content may be received in a raw or uncompressed format, e.g., 8 or 10 bit multi-component pixel values, or may be in a compressed or encoded format. The input 4002 may represent a network interface, a peripheral bus interface, or a storage interface. Examples of network interface include wired interfaces such as Ethernet, passive optical network (PON), etc. and wireless interfaces such as wireless fidelity (Wi-Fi) or cellular interfaces.

The system 4000 may include a coding component 4004 that may implement the various coding or encoding methods described in the present disclosure. The coding component 4004 may reduce the average bitrate of video from the input 4002 to the output of the coding component 4004 to produce a coded representation of the video. The coding techniques are therefore sometimes called video compression or video transcoding techniques. The output of the coding component 4004 may be either stored, or transmitted via a communication connected, as represented by the component 4006. The stored or communicated bitstream (or coded) representation of the video received at the input 4002 may be used by a component 4008 for generating pixel values or displayable video that is sent to a display interface 4010. The process of generating user-viewable video from the bitstream representation is sometimes called video decompression. Furthermore, while certain video processing operations are referred to as “coding” operations or tools, it will be appreciated that the coding tools or operations are used at an encoder and corresponding decoding tools or operations that reverse the results of the coding will be performed by a decoder.

Examples of a peripheral bus interface or a display interface may include universal serial bus (USB) or high definition multimedia interface (HDMI) or Displayport, and so on. Examples of storage interfaces include serial advanced technology attachment (SATA), peripheral component interconnect (PCI), integrated drive electronics (IDE) interface, and the like. The techniques described in the present disclosure may be embodied in various electronic devices such as mobile phones, laptops, smartphones or other devices that are capable of performing digital data processing and/or video display.

FIG. 4 is a block diagram of an example video processing apparatus 4100. The apparatus 4100 may be used to implement one or more of the methods described herein. The apparatus 4100 may be embodied in a smartphone, tablet, computer, Internet of Things (IoT) receiver, and so on. The apparatus 4100 may include one or more processors 4102, one or more memories 4104 and video processing circuitry 4106. The processor(s) 4102 may be configured to implement one or more methods described in the present disclosure. The memory (memories) 4104 may be used for storing data and code used for implementing the methods and techniques described herein. The video processing circuitry 4106 may be used to implement, in hardware circuitry, some techniques described in the present disclosure. In some embodiments, the video processing circuitry 4106 may be at least partly included in the processor 4102, e.g., a graphics co-processor.

FIG. 5 is a flowchart for an example method 4200 of video processing. At step 402, a determination is made to arrange displacement vectors and an attribute map of three-dimensional (3D) visual media data into a single picture for processing by a two-dimensional (2D) codec. At step 4204, a conversion is performed between a visual media data and a bitstream based on the displacement vectors and the attribute map. The conversion of step 4204 may include encoding at an encoder or decoding at a decoder, depending on the example.

It should be noted that the method 4200 can be implemented in an apparatus for processing video data comprising a processor and a non-transitory memory with instructions thereon, such as video encoder 4400, video decoder 4500, and/or encoder 4600. In such a case, the instructions upon execution by the processor, cause the processor to perform the method 4200. Further, the method 4200 can be performed by a non-transitory computer readable medium comprising a computer program product for use by a video coding device. The computer program product comprises computer executable instructions stored on the non-transitory computer readable medium such that when executed by a processor cause the video coding device to perform the method 4200. Further, a non-transitory computer-readable recording medium may store a bitstream of a video which is generated by the method 4200 as performed by a video processing apparatus. In addition, the method 4200 can be performed by an apparatus for processing video data comprising a processor and a non-transitory memory with instructions thereon. The instructions, upon execution by the processor, cause the processor to perform method 4200.

FIG. 6 is a block diagram that illustrates an example video coding system 4300 that may utilize the techniques of this disclosure. The video coding system 4300 may include a source device 4310 and a destination device 4320. Source device 4310 generates encoded video data which may be referred to as a video encoding device. Destination device 4320 may decode the encoded video data generated by source device 4310 which may be referred to as a video decoding device.

Source device 4310 may include a video source 4312, a video encoder 4314, and an input/output (I/O) interface 4316. Video source 4312 may include a source such as a video capture device, an interface to receive video data from a video content provider, and/or a computer graphics system for generating video data, or a combination of such sources. The video data may comprise one or more pictures. Video encoder 4314 encodes the video data from video source 4312 to generate a bitstream. The bitstream may include a sequence of bits that form a coded representation of the video data. The bitstream may include coded pictures and associated data. The coded picture is a coded representation of a picture. The associated data may include sequence parameter sets, picture parameter sets, and other syntax structures. I/O interface 4316 may include a modulator/demodulator (modem) and/or a transmitter. The encoded video data may be transmitted directly to destination device 4320 via I/O interface 4316 through network 4330. The encoded video data may also be stored onto a storage medium/server 4340 for access by destination device 4320.

Destination device 4320 may include an I/O interface 4326, a video decoder 4324, and a display device 4322. I/O interface 4326 may include a receiver and/or a modem. I/O interface 4326 may acquire encoded video data from the source device 4310 or the storage medium/server 4340. Video decoder 4324 may decode the encoded video data. Display device 4322 may display the decoded video data to a user. Display device 4322 may be integrated with the destination device 4320, or may be external to destination device 4320, which can be configured to interface with an external display device.

Video encoder 4314 and video decoder 4324 may operate according to a video compression standard, such as the High Efficiency Video Coding (HEVC) standard, Versatile Video Coding (VVC) standard and other current and/or further standards.

FIG. 7 is a block diagram illustrating an example of video encoder 4400, which may be video encoder 4314 in the system 4300 illustrated in FIG. 6. Video encoder 4400 may be configured to perform any or all of the techniques of this disclosure. The video encoder 4400 includes a plurality of functional components. The techniques described in this disclosure may be shared among the various components of video encoder 4400. In some examples, a processor may be configured to perform any or all of the techniques described in this disclosure.

The functional components of video encoder 4400 may include a partition unit 4401, a prediction unit 4402 which may include a mode select unit 4403, a motion estimation unit 4404, a motion compensation unit 4405, an intra prediction unit 4406, a residual generation unit 4407, a transform processing unit 4408, a quantization unit 4409, an inverse quantization unit 4410, an inverse transform unit 4411, a reconstruction unit 4412, a buffer 4413, and an entropy encoding unit 4414.

In other examples, video encoder 4400 may include more, fewer, or different functional components. In an example, prediction unit 4402 may include an intra block copy (IBC) unit. The IBC unit may perform prediction in an IBC mode in which at least one reference picture is a picture where the current video block is located.

Furthermore, some components, such as motion estimation unit 4404 and motion compensation unit 4405 may be highly integrated, but are represented in the example of video encoder 4400 separately for purposes of explanation.

Partition unit 4401 may partition a picture into one or more video blocks. Video encoder 4400 and video decoder 4500 may support various video block sizes.

Mode select unit 4403 may select one of the coding modes, intra or inter, e.g., based on error results, and provide the resulting intra or inter coded block to a residual generation unit 4407 to generate residual block data and to a reconstruction unit 4412 to reconstruct the encoded block for use as a reference picture. In some examples, mode select unit 4403 may select a combination of intra and inter prediction (CIIP) mode in which the prediction is based on an inter prediction signal and an intra prediction signal. Mode select unit 4403 may also select a resolution for a motion vector (e.g., a sub-pixel or integer pixel precision) for the block in the case of inter prediction.

To perform inter prediction on a current video block, motion estimation unit 4404 may generate motion information for the current video block by comparing one or more reference frames from buffer 4413 to the current video block. Motion compensation unit 4405 may determine a predicted video block for the current video block based on the motion information and decoded samples of pictures from buffer 4413 other than the picture associated with the current video block.

Motion estimation unit 4404 and motion compensation unit 4405 may perform different operations for a current video block, for example, depending on whether the current video block is in an I slice, a P slice, or a B slice.

In some examples, motion estimation unit 4404 may perform uni-directional prediction for the current video block, and motion estimation unit 4404 may search reference pictures of list 0 or list 1 for a reference video block for the current video block. Motion estimation unit 4404 may then generate a reference index that indicates the reference picture in list 0 or list 1 that contains the reference video block and a motion vector that indicates a spatial displacement between the current video block and the reference video block. Motion estimation unit 4404 may output the reference index, a prediction direction indicator, and the motion vector as the motion information of the current video block. Motion compensation unit 4405 may generate the predicted video block of the current block based on the reference video block indicated by the motion information of the current video block.

In other examples, motion estimation unit 4404 may perform bi-directional prediction for the current video block, motion estimation unit 4404 may search the reference pictures in list 0 for a reference video block for the current video block and may also search the reference pictures in list 1 for another reference video block for the current video block. Motion estimation unit 4404 may then generate reference indexes that indicate the reference pictures in list 0 and list 1 containing the reference video blocks and motion vectors that indicate spatial displacements between the reference video blocks and the current video block. Motion estimation unit 4404 may output the reference indexes and the motion vectors of the current video block as the motion information of the current video block. Motion compensation unit 4405 may generate the predicted video block of the current video block based on the reference video blocks indicated by the motion information of the current video block.

In some examples, motion estimation unit 4404 may output a full set of motion information for decoding processing of a decoder. In some examples, motion estimation unit 4404 may not output a full set of motion information for the current video. Rather, motion estimation unit 4404 may signal the motion information of the current video block with reference to the motion information of another video block. For example, motion estimation unit 4404 may determine that the motion information of the current video block is sufficiently similar to the motion information of a neighboring video block.

In one example, motion estimation unit 4404 may indicate, in a syntax structure associated with the current video block, a value that indicates to the video decoder 4500 that the current video block has the same motion information as another video block.

In another example, motion estimation unit 4404 may identify, in a syntax structure associated with the current video block, another video block and a motion vector difference (MVD). The motion vector difference indicates a difference between the motion vector of the current video block and the motion vector of the indicated video block. The video decoder 4500 may use the motion vector of the indicated video block and the motion vector difference to determine the motion vector of the current video block.

As discussed above, video encoder 4400 may predictively signal the motion vector. Two examples of predictive signaling techniques that may be implemented by video encoder 4400 include advanced motion vector prediction (AMVP) and merge mode signaling.

Intra prediction unit 4406 may perform intra prediction on the current video block. When intra prediction unit 4406 performs intra prediction on the current video block, intra prediction unit 4406 may generate prediction data for the current video block based on decoded samples of other video blocks in the same picture. The prediction data for the current video block may include a predicted video block and various syntax elements.

Residual generation unit 4407 may generate residual data for the current video block by subtracting the predicted video block(s) of the current video block from the current video block. The residual data of the current video block may include residual video blocks that correspond to different sample components of the samples in the current video block.

In other examples, there may be no residual data for the current video block for the current video block, for example in a skip mode, and residual generation unit 4407 may not perform the subtracting operation.

Transform processing unit 4408 may generate one or more transform coefficient video blocks for the current video block by applying one or more transforms to a residual video block associated with the current video block.

After transform processing unit 4408 generates a transform coefficient video block associated with the current video block, quantization unit 4409 may quantize the transform coefficient video block associated with the current video block based on one or more quantization parameter (QP) values associated with the current video block.

Inverse quantization unit 4410 and inverse transform unit 4411 may apply inverse quantization and inverse transforms to the transform coefficient video block, respectively, to reconstruct a residual video block from the transform coefficient video block. Reconstruction unit 4412 may add the reconstructed residual video block to corresponding samples from one or more predicted video blocks generated by the prediction unit 4402 to produce a reconstructed video block associated with the current block for storage in the buffer 4413.

After reconstruction unit 4412 reconstructs the video block, the loop filtering operation may be performed to reduce video blocking artifacts in the video block.

Entropy encoding unit 4414 may receive data from other functional components of the video encoder 4400. When entropy encoding unit 4414 receives the data, entropy encoding unit 4414 may perform one or more entropy encoding operations to generate entropy encoded data and output a bitstream that includes the entropy encoded data.

FIG. 8 is a block diagram illustrating an example of video decoder 4500 which may be video decoder 4324 in the system 4300 illustrated in FIG. 6. The video decoder 4500 may be configured to perform any or all of the techniques of this disclosure. In the example shown, the video decoder 4500 includes a plurality of functional components. The techniques described in this disclosure may be shared among the various components of the video decoder 4500. In some examples, a processor may be configured to perform any or all of the techniques described in this disclosure.

In the example shown, video decoder 4500 includes an entropy decoding unit 4501, a motion compensation unit 4502, an intra prediction unit 4503, an inverse quantization unit 4504, an inverse transformation unit 4505, a reconstruction unit 4506, and a buffer 4507. Video decoder 4500 may, in some examples, perform a decoding pass generally reciprocal to the encoding pass described with respect to video encoder 4400.

Entropy decoding unit 4501 may retrieve an encoded bitstream. The encoded bitstream may include entropy coded video data (e.g., encoded blocks of video data). Entropy decoding unit 4501 may decode the entropy coded video data, and from the entropy decoded video data, motion compensation unit 4502 may determine motion information including motion vectors, motion vector precision, reference picture list indexes, and other motion information. Motion compensation unit 4502 may, for example, determine such information by performing the AMVP and merge mode.

Motion compensation unit 4502 may produce motion compensated blocks, possibly performing interpolation based on interpolation filters. Identifiers for interpolation filters to be used with sub-pixel precision may be included in the syntax elements.

Motion compensation unit 4502 may use interpolation filters as used by video encoder 4400 during encoding of the video block to calculate interpolated values for sub-integer pixels of a reference block. Motion compensation unit 4502 may determine the interpolation filters used by video encoder 4400 according to received syntax information and use the interpolation filters to produce predictive blocks.

Motion compensation unit 4502 may use some of the syntax information to determine sizes of blocks used to encode frame(s) and/or slice(s) of the encoded video sequence, partition information that describes how each macroblock of a picture of the encoded video sequence is partitioned, modes indicating how each partition is encoded, one or more reference frames (and reference frame lists) for each inter coded block, and other information to decode the encoded video sequence.

Intra prediction unit 4503 may use intra prediction modes for example received in the bitstream to form a prediction block from spatially adjacent blocks. Inverse quantization unit 4504 inverse quantizes, i.e., de-quantizes, the quantized video block coefficients provided in the bitstream and decoded by entropy decoding unit 4501. Inverse transform unit 4505 applies an inverse transform.

Reconstruction unit 4506 may sum the residual blocks with the corresponding prediction blocks generated by motion compensation unit 4502 or intra prediction unit 4503 to form decoded blocks. If desired, a deblocking filter may also be applied to filter the decoded blocks in order to remove blockiness artifacts. The decoded video blocks are then stored in buffer 4507, which provides reference blocks for subsequent motion compensation/intra prediction and also produces decoded video for presentation on a display device.

FIG. 9 is a schematic diagram of an example encoder 4600. The encoder 4600 is suitable for implementing the techniques of VVC. The encoder 4600 includes three in-loop filters, namely a deblocking filter (DF) 4602, a sample adaptive offset (SAO) 4604, and an adaptive loop filter (ALF) 4606. Unlike the DF 4602, which uses predefined filters, the SAO 4604 and the ALF 4606 utilize the original samples of the current picture to reduce the mean square errors between the original samples and the reconstructed samples by adding an offset and by applying a finite impulse response (FIR) filter, respectively, with coded side information signaling the offsets and filter coefficients. The ALF 4606 is located at the last processing stage of each picture and can be regarded as a tool trying to catch and fix artifacts created by the previous stages.

The encoder 4600 further includes an intra prediction component 4608 and a motion estimation/compensation (ME/MC) component 4610 configured to receive input video. The intra prediction component 4608 is configured to perform intra prediction, while the ME/MC component 4610 is configured to utilize reference pictures obtained from a reference picture buffer 4612 to perform inter prediction. Residual blocks from inter prediction or intra prediction are fed into a transform (T) component 4614 and a quantization (Q) component 4616 to generate quantized residual transform coefficients, which are fed into an entropy coding component 4618. The entropy coding component 4618 entropy codes the prediction results and the quantized transform coefficients and transmits the same toward a video decoder (not shown). Quantization components output from the quantization component 4616 may be fed into an inverse quantization (IQ) components 4620, an inverse transform component 4622, and a reconstruction (REC) component 4624. The REC component 4624 is able to output images to the DF 4602, the SAO 4604, and the ALF 4606 for filtering prior to those images being stored in the reference picture buffer 4612.

A listing of solutions preferred by some examples is provided next.

The following solutions show examples of techniques discussed herein.
1. A method for processing video or image data comprising: determining to arrange displacement vectors and an attribute map of three-dimensional (3D) visual media data into a single picture for processing by a two-dimensional (2D) codec; and performing a conversion between visual media data and a bitstream based on the displacement vectors and the attribute map.
2. The method of solution 1, wherein the displacement vectors and the attribute map are concatenated to form a picture.
3. The method of any of solutions 1-2, wherein the displacement vectors and the attribute map are arranged in different parts of one picture, and wherein location or size information of each part is indicated in the bitstream.
4. The method of any of solutions 1-3, wherein the location or size information of each part is signaled or derived based on signaling in a sequence parameter set (SPS), picture parameter set (PPS), video parameter set (VPS), picture header, or slice header.
5. The method of any of solutions 1-4, wherein the displacement vectors and the attribute map are arranged in different parts of one picture, and wherein each part is independently decodable.
6. The method of any of solutions 1-5, wherein the displacement vectors and the attribute map are arranged in different slices, tiles, or sub-pictures in one picture.
7. The method of any of solutions 1-6, wherein the displacement vectors and the attribute map are coded using constrained intra prediction or motion constrained tile sets so that each part is independently decodable.
8. The method of any of solutions 1-7, wherein the displacement vectors and the attribute map are aligned to one bitdepth and arranged in one picture.
9. The method of any of solutions 1-8, wherein a displacement vector bitdepth is aligned to an attribute map bitdepth, the attribute map bitdepth is aligned to the displacement vector bitdepth, or a lower bitdepth is aligned to a higher bitdepth.
10. The method of any of solutions 1-9, wherein the displacement vectors and the attribute map are aligned to one color format and arranged in one picture.
11. The method of any of solutions 1-10, wherein a displacement vector color format is aligned to an attribute map color format, the attribute map color format is aligned to the displacement vector color format, or a lower information color format is aligned to a higher information color format.
12. The method of any of solutions 1-11, wherein a motion field of meshes and displacement vectors are arranged into one picture for processing by the 2D codec.
13. The method of any of solutions 1-12, wherein a motion field of meshes and the attribute map are arranged into one picture for processing by the 2D codec.
14. The method of any of solutions 1-13, wherein the motion field of meshes, the attribute map, and the displacement vectors are arranged into one picture for processing by the 2D codec.
15. The method of any of solutions 1-14, wherein two or more of the motion field of meshes, the attribute map, and the displacement vectors are aligned to one bitdepth or aligned to one color format.
16. The method of any of solutions 1-15, wherein two or more of an occupancy map, a geometry, and an attribute are arranged into one picture for processing by the 2D codec.
17. The method of any of solutions 1-16, wherein two or more of the occupancy map, the geometry, and the attribute are aligned to one bitdepth or aligned to one color format.
18. An apparatus for processing video data comprising: a processor; and a non-transitory memory with instructions thereon, wherein the instructions upon execution by the processor, cause the processor to perform the method of any of solutions 1-17.
19. A non-transitory computer readable medium comprising a computer program product for use by a video coding device, the computer program product comprising computer executable instructions stored on the non-transitory computer readable medium such that when executed by a processor cause the video coding device to perform the method of any of solutions 1-17.
20. A non-transitory computer-readable recording medium storing a bitstream of a video which is generated by a method performed by a video processing apparatus, wherein the method comprises: determining to arrange displacement vectors and an attribute map of three-dimensional (3D) visual media data into a single picture for processing by a two-dimensional (2D) codec; and generating a bitstream based on the determining.
21. A method for storing bitstream of a video comprising: determining to arrange displacement vectors and an attribute map of three-dimensional (3D) visual media data into a single picture for processing by a two-dimensional (2D) codec; generating a bitstream based on the determining; and storing the bitstream in a non-transitory computer-readable recording medium.
22. A method, apparatus or system described in the present disclosure.

In the solutions described herein, an encoder may conform to the format rule by producing a coded representation according to the format rule. In the solutions described herein, a decoder may use the format rule to parse syntax elements in the coded representation with the knowledge of presence and absence of syntax elements according to the format rule to produce decoded video.

In the present disclosure, the term “video processing” may refer to video encoding, video decoding, video compression or video decompression. For example, video compression algorithms may be applied during conversion from pixel representation of a video to a corresponding bitstream representation or vice versa. The bitstream representation of a current video block may, for example, correspond to bits that are either co-located or spread in different places within the bitstream, as is defined by the syntax. For example, a macroblock may be encoded in terms of transformed and coded error residual values and also using bits in headers and other fields in the bitstream. Furthermore, during conversion, a decoder may parse a bitstream with the knowledge that some fields may be present, or absent, based on the determination, as is described in the above solutions. Similarly, an encoder may determine that certain syntax fields are or are not to be included and generate the coded representation accordingly by including or excluding the syntax fields from the coded representation.

The disclosed and other solutions, examples, embodiments, modules and the functional operations described in this disclosure can be implemented in digital electronic circuitry, or in computer software, firmware, or hardware, including the structures disclosed in this disclosure and their structural equivalents, or in combinations of one or more of them. The disclosed and other embodiments can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this disclosure can be performed by one or more programmable processors executing one or more computer programs to perform functions by operating on input data and generating output. The processes and logic flows can also be performed by, and apparatus can also be implemented as, special purpose logic circuitry, e.g., a field programmable gate array (FPGA) or an application specific integrated circuit (ASIC).

Processors suitable for the execution of a computer program include, by way of example, both general and special purpose microprocessors, and any one or more processors of any kind of digital computer. Generally, a processor will receive instructions and data from a read only memory or a random-access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., erasable programmable read-only memory (EPROM), electrically erasable programmable read-only memory (EEPROM), and flash memory devices; magnetic disks, e.g., internal hard disks or removable disks; magneto optical disks; and compact disc read-only memory (CD ROM) and Digital versatile disc-read only memory (DVD-ROM) disks. The processor and the memory can be supplemented by, or incorporated in, special purpose logic circuitry.

While the present disclosure contains many specifics, these should not be construed as limitations on the scope of any subject matter or of what may be claimed, but rather as descriptions of features that may be specific to particular embodiments of particular techniques. Certain features that are described in the present disclosure in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in the present disclosure should not be understood as requiring such separation in all embodiments.

Only a few implementations and examples are described and other implementations, enhancements and variations can be made based on what is described and illustrated in the present disclosure.

A first component is directly coupled to a second component when there are no intervening components, except for a line, a trace, or another medium between the first component and the second component. The first component is indirectly coupled to the second component when there are intervening components other than a line, a trace, or another medium between the first component and the second component. The term “coupled” and its variants include both directly coupled and indirectly coupled. The use of the term “about” means a range including ±10% of the subsequent number unless otherwise stated.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled may be directly connected or may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

What is claimed is:

1. A method for processing video or image data, comprising:
determining to arrange displacement vectors and an attribute map of three-dimensional (3D) visual media data into a single picture for processing by a two-dimensional (2D) video codec; and
performing a conversion between visual media data and a bitstream based on the displacement vectors and the attribute map.

2. The method of claim 1, further comprising determining to arrange the displacement vectors and the attribute map in different parts of the single picture, and indicating location information or size information for each of the different parts in the bitstream.

3. The method of claim 2, further comprising indicating the location information or the size information in a sequence parameter set (SPS), a picture parameter set (PPS), a video parameter set (VPS), a picture header, or a slice header of the bitstream.

4. The method of claim 2, further comprising deriving the location information or the size information from information in a sequence parameter set (SPS), a picture parameter set (PPS), a video parameter set (VPS), a picture header, or a slice header of the bitstream.

5. The method of claim 1, further comprising aligning the displacement vectors and the attribute map to a single bitdepth prior to determining to arrange the displacement vectors and the attribute map into the single picture.

6. The method of claim 5, further comprising aligning a bitdepth of the displacement vectors to the attribute map so that the displacement vectors and the attribute map are aligned to the single bitdepth.

7. The method of claim 5, further comprising aligning a bitdepth of the attribute map to the displacement vectors so that the displacement vectors and the attribute map are aligned to the single bitdepth.

8. The method of claim 5, further comprising aligning a first portion of data with a bitdepth lower than the single bitdepth to a second portion of data with a bitdepth higher than the single bitdepth so that the displacement vectors and the attribute map are aligned to the single bitdepth.

9. The method of claim 1, further comprising aligning the displacement vectors and the attribute map to a single color format prior to determining to arrange the displacement vectors and the attribute map into the single picture.

10. The method of claim 9, further comprising aligning a color format of the displacement vectors to the attribute map so that the displacement vectors and the attribute map are aligned to the single color format.

11. The method of claim 9, further comprising aligning a color format of the attribute map to the displacement vectors so that the displacement vectors and the attribute map are aligned to the single color format.

12. The method of claim 9, further comprising aligning a portion of data with a less color format information to a portion of data with more color format information so that the displacement vectors and the attribute map are aligned to the single color format.

13. The method of claim 1, wherein the conversion includes encoding the visual media data into the bitstream.

14. The method of claim 1, wherein the conversion includes decoding the visual media data from the bitstream.

15. An apparatus for processing media data comprising: a processor; and a non-transitory memory with instructions thereon, wherein the instructions upon execution by the processor, cause the processor to:
determine to arrange displacement vectors and an attribute map of three-dimensional (3D) visual media data into a single picture for processing by a two-dimensional (2D) video codec; and
perform a conversion between visual media data and a bitstream based on the displacement vectors and the attribute map.

16. The apparatus of claim 15, wherein the processor is further caused to:
determine to arrange the displacement vectors and the attribute map in different parts of the single picture, and indicating location information or size information for each of the different parts in the bitstream;
align the displacement vectors and the attribute map to a single bitdepth prior to determining to arrange the displacement vectors and the attribute map into the single picture; and
align the displacement vectors and the attribute map to a single color format prior to determining to arrange the displacement vectors and the attribute map into the single picture.

17. A non-transitory computer readable storage medium storing instructions that cause a processor to:
determine to arrange displacement vectors and an attribute map of three-dimensional (3D) visual media data into a single picture for processing by a two-dimensional (2D) video codec; and
perform a conversion between visual media data and a bitstream based on the displacement vectors and the attribute map.

18. The non-transitory computer readable storage medium of claim 17, wherein the processor is further caused to:
determine to arrange the displacement vectors and the attribute map in different parts of the single picture, and indicating location information or size information for each of the different parts in the bitstream;
align the displacement vectors and the attribute map to a single bitdepth prior to determining to arrange the displacement vectors and the attribute map into the single picture; and
align the displacement vectors and the attribute map to a single color format prior to determining to arrange the displacement vectors and the attribute map into the single picture.

19. A non-transitory computer-readable recording medium storing a bitstream of a video which is generated by a method performed by a video processing apparatus, wherein the method comprises:
determining to arrange displacement vectors and an attribute map of three-dimensional (3D) visual media data into a single picture for processing by a two-dimensional (2D) video codec; and
generating the bitstream based on the displacement vectors and the attribute map.

20. The non-transitory computer-readable recording medium of claim 19, wherein the method further comprises:
determining to arrange the displacement vectors and the attribute map in different parts of the single picture, and indicating location information or size information for each of the different parts in the bitstream;
aligning the displacement vectors and the attribute map to a single bitdepth prior to determining to arrange the displacement vectors and the attribute map into the single picture; and
aligning the displacement vectors and the attribute map to a single color format prior to determining to arrange the displacement vectors and the attribute map into the single picture.
